(19) United States
(12) Patent Application Publication
(10) Pub. No.: US 2016/0148639 A1
(43) Pub. Date: May 26, 2016

(54) SCREWLESS DISC CLAMP

(71) Applicant: Seagate Technology LLC, Cupertino, CA (US)

(72) Inventor: Lynn Bich-Quy Le, San Jose, CA (US)

(21) Appl. No.: 14/550,846

(22) Filed: Nov. 21, 2014

(51) Int. Cl. G11B 19/20

(52) U.S. Cl. CPC G11B 19/2045

(57) ABSTRACT

Provided herein is an apparatus that includes a radially extending through hole in an interperimeteral region and a radial channel extending from the through hole to an inner perimeter of an annulus. The radially extending through hole and the radial channel define a compliant flange operable to engage an annular groove. In some embodiments, the apparatus may be used as a screwless disk clamp in a hard disk drive.

### BACKGROUND

A hard disk drive (HDD) includes one or more disks for storing digital data, which one or more disks are clamped to a spindle motor assembly for rotation during read-write operations. The conventional, screw-based disk clamp that is used to clamp the one or more disks to the spindle motor assembly requires a dedicated space for the clamp and the one or more screws used to fasten the disks to the spindle motor assembly. The height of the dedicated space required for the screw-based disk clamp takes an amount of length away from the bearing span of the spindle.

### SUMMARY

Provided herein is an apparatus that includes an inner perimeter, an outer perimeter, and an interperimeteral region of an annulus. The apparatus also includes a top and bottom surface of the annulus and a number of radially extending through holes through the top and bottom surfaces of the interperimeteral region of the annulus. Two or more of the through holes radially extend through a radial channel to the inner perimeter of the annulus to form compliant flanges that are operable to engage an annular groove of a hub.

Also provided herein is an apparatus that includes a radially extending through hole in an interperimeteral region and a radial channel extending from the through hole to an inner perimeter of an annulus. The radially extending through hole and the radial channel define a compliant flange operable to engage an annular groove.

Also provided herein is an apparatus that includes an interperimeteral region of an annulus and a number of radially extending through holes through the interperimeteral region of the annulus. One or more of the through holes radially extends to an inner perimeter of the annulus, thereby forming flanges operable to engage an annular groove of a hub.

These and other aspects and features of the invention may be better understood with reference to the following drawings, description, and appended claims.

### DRAWINGS

FIG. 1A illustrates an example disk clamp, according to one aspect of the present description.

FIG. 1B illustrates another example disk clamp, according to one aspect of the present description.

FIG. 2 illustrates an example disk clamp clamping a disk onto a hub, according to one aspect of the present description.

FIG. 3 illustrates a tool operating on a disk clamp to clamp a disk onto a hub, according to one aspect of the present description.

FIG. 4 provides a HDD in which a disk clamp may be used, according to one aspect of the present description.

### DESCRIPTION

Before embodiments of the invention are described in greater detail, it should be understood by persons having ordinary skill in the art to which the invention pertains that the invention is not limited to the particular embodiments described and/or illustrated herein, as elements in such embodiments may vary. It should likewise be understood that a particular embodiment described and/or illustrated herein has elements that may be readily separated from the particular embodiment and optionally combined with any of several other embodiments or substituted for elements in any of several other embodiments described herein.

It should also be understood by persons having ordinary skill in the art to which the invention pertains that the terminology used herein is for the purpose of describing embodiments of the invention, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the claimed invention, or embodiments thereof. For example, “first,” “second,” and “third” elements or steps need not necessarily appear in that order, and the claimed invention, or embodiments thereof, need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like, are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art to which the invention pertains.

Embodiments of the invention will now be described in greater detail. Conventional HDDs may include one or more data storage disks supported on a hub for rotation by a spindle motor assembly. The one or more data storage disks each have a central opening defining an inner diameter through which a spindle of the spindle motor assembly extends. Each disk is secured at its inner diameter to the hub in a fixed relation with the spindle, and each disk is supported such that its outer diameter is free from contact with other components. When the spindle is rotatably driven by the spindle motor, the one or more data storage disks rotate with the spindle.

In securing the one or more data storage disks to the hub, the disks may be alternately stacked with spacer rings on the hub that define the core of the disk stack. The disks of the disk stack are typically secured onto the hub by a disk clamp that fits over the top of the hub. HDDs may use a screw-based disk clamp to secure the one or more data storage disks of the disk pack in place on the hub. The height of the dedicated space required for the screw-based disk clamp takes an amount of length away from the bearing span of the spindle, height that could instead be used to increase the bearing span and, thus, gyroscopic performance. Described herein are various embodiments of disk clamps that do not require screws and/or reclaim height-based space increasing bearing span.

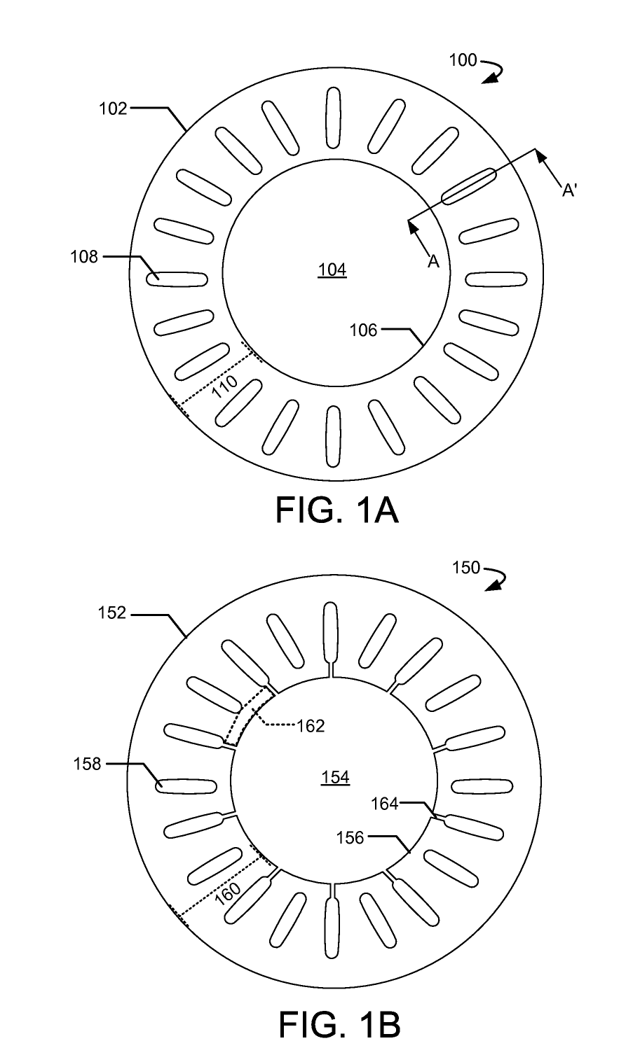

FIG. 1A illustrates an example disk clamp, according to one aspect of the present description. Although this disclosure illustrates and describes disk clamps with example configuration of flanges, through holes, and radial channels with respect to the interperimeteral region of the disk clamp, this disclosure contemplates and includes any suitable configuration of flanges, through holes, and with or without radial channels. In some embodiments, disk clamps in accordance with FIGS. 1A-B are provided to secure a disk onto a hub without a separate fastener, e.g., screw.

As illustrated in FIG. 1A, disk clamp 100 may include an outer perimeter 102, an inner opening 104, an inner perimeter 106 of inner opening 104, and an interperimeteral region 110. Herein, reference to an interperimeteral region 110 may refer to the annular region between inner perimeter 106 and outer perimeter 102 of disk clamp 100. Interperimeteral region 110 may include a number of through holes 108 that each radially extends from inner opening 104 in a direction between inner perimeter 106 and outer perimeter 102. The configuration or dimension of through holes 108 may determine the force that secures a disk to the hub. By removing material from interperimeteral region 110, a portion of interperimeteral region 110 may become less rigid or compliant, as described below. For example, the portion of interperimeteral region 110 from inner perimeter 106 up to or including a portion of through holes 108 may be compliant due to the presence of through holes 108. The compliant portion of interperimeteral region 110 may be configured to engage an annular groove of a hub. In some embodiments, disk clamp 100 may include an even number of through holes 108. In some embodiments, disk clamp 100 may include an odd number of through holes 108. In other embodiments, inner perimeter 106 may include one or more notches (not shown). The notches of inner perimeter 106 may provide clearance for one or more corresponding protruding disk clamp retainers of the hub. Disk clamp 100 may be passed through the protruding disk clamp retainers of the hub and may be twisted in position on to the hub in various embodiments.

FIG. 1B illustrates another example disk clamp, according to one aspect of the present description. As illustrated in FIG. 1B, disk clamp 150 may include an outer perimeter 152, inner opening 154, inner perimeter 156, through holes 158, and interperimeteral region 160 that correspond to outer perimeter 102, an inner opening 104, an inner perimeter 106, through holes 108, and interperimeteral region 110, respectively, of disk clamp 100 in FIG. 1A. One or more through holes 158 may include a radial channel 164 that radially extends from the corresponding through hole 158 to inner perimeter 156. Radial channel 164 may have a width that is less than the width of the corresponding through hole 158. Through holes 158 and radial channels 164 may have a depth that extends from the top surface through the thickness of the material of disk clamp 150 to the bottom surface.

In some embodiments, a pair of radial channels 164 may define flanges 162 that are operable to engage an annular groove of a hub. Although this disclosure illustrates and describes flanges defined by alternating through holes having radial channels, this disclosure contemplates and includes flanges defined any suitable configuration of through holes with radial channels, e.g., radial channels in each through hole, every third through hole, etc. In some embodiments, each flange 162 may include at least one completely enclosed through hole 158 that does not have a radial channel 164. In some embodiments, disk clamp 150 may include an even number of flanges 162. In some embodiments, disk clamp 150 may include an odd number of flanges 162. In some embodiments, disk clamp 150 may include at least 2, 3, 4, 5, 6, 7, 8, 9, 10, 11, or 12 flanges 162, or more, such as at least 24, 36, 48 or 60 flanges 162.

In some embodiments, flanges 162 may be compliant or capable of elastic deformation. For example, the portion of interperimeteral region 160 from inner perimeter 156 to the closest extent of each through hole 158 may be compliant due to the presence of through holes 158 and radial channels 164. Excepting the portion of interperimeteral region 160 that forms flanges 162, the remaining portion of disk clamp 150 may be non-compliant. For example, the portion of interperimeteral region 160 from the outer perimeter 152 of disk clamp 150 to the extent of through holes 158 nearest to inner perimeter 158 may be a non-compliant based on the dimensions of through holes 158 and the absence of radial channels 164.

The geometric and structural relationships of disc clamp 100 and 150 determine the clamp force provide by disc clamp 100 and 150. For example, the geometric and structural relationships of disk clamp 100, for example the thickness of disk clamp 100 and 150, shape or dimensions of through holes 108 and 158, configuration of through holes 158 with radial channels 164, the number of flanges 162, etc., may be configured to provide sufficient clamp force so that the disks may be rotated at the proper speed for the intended HDD configuration. The compliant portion of disk clamps 100 and 150 includes a portion of interperimeteral region 110 and 160 of disk clamps 100 and 150, respectively, and flanges as appropriate.

In some embodiments, disk clamps 100 and 150 may be fabricated using a material having a relatively low thermal expansion coefficient. For example, disk clamps 100 and 150 may be fabricated using a material having a volumetric coefficient less than 70×10⁻⁶ per° C., 55×10⁻⁶ per° C., 40×10⁻⁶ per° C., 35×10⁻⁶ per° C., 30×10⁻⁶ per° C., etc. In some embodiments, the disk clamp may be fabricated using a material having a relatively low thermal expansion coefficient, e.g., volumetric coefficient, in a temperature range of approximately 5° C. to approximately 60° C. that corresponds to the normal operating temperature range for HDDs. In such embodiments, the disk clamp may comprise aluminum, steel, e.g., stainless steel or carbon steel, plastic, etc.

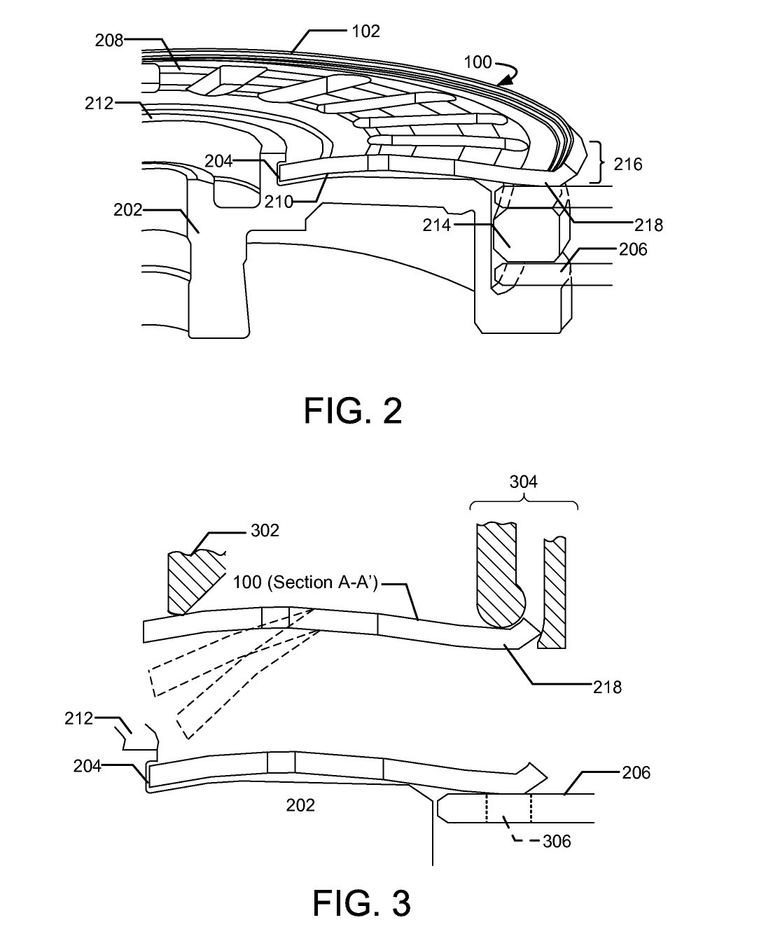

FIG. 2 illustrates an example disk clamp clamping a disk onto a hub, according to one aspect of the present description. As described above, a HDD may include a stack of disks 206 of magnetic media. For example, the disk stack may include a number of disks 206 stacked with a spacer ring 214 between alternate disks 206. The disk clamp 100, as previously described in FIG. 1A, may screwlessly secure disks 206 on to a hub 202. Although this disclosure illustrates and describes securing disk using an example disk clamp having a compliant portion formed from a particular configuration of through holes, this disclosure contemplates and includes any suitable disk clamp having a compliant portion formed from any suitable configuration of flanges, through holes, and with or without radial channels, for example, the disk clamp previously described in FIG. 1B. The through holes and radial channels may have a depth that extends from a top surface 208 through the thickness of the material of disk clamp 100 to a bottom surface 210.

When in position or seated on hub 202, the free or non-deflected compliant portion of the disk clamp are configured to engage an annular groove 204 of hub 202. Annular groove 204 may be defined by rim 212 of hub 202 and a sloped annular seat of hub 202 in which the compliant portion of disk clamp 100 is seated when securing disks 206 onto hub 202. Outer perimeter 102 of the disk clamp includes a rim 216, where a bottom portion 218 of rim 216 is operable to apply a substantially uniform pressure or clamping force on an inner annulus of disk 206 on hub 202. For example, the pressure or clamping force that bottom portion 218 applies to disk 206 may be within ±5% of the average clamping force over the area of bottom portion 218 that is in contact with the surface of disk 206. For instance, in the case where bottom portion 218 applies a clamping force of 200 kilogram-force (kgf) to disk 206, the clamping force over the area of contact between bottom portion 218 and disk 206 may be within a range of approximately 190 kgf to approximately 210 kgf. As described above, the geometric and structural relationships of disk clamp 100 may be configured to provide sufficient clamp force so that disks 206 may be rotated at the proper speed for the intended HDD configuration.

FIG. 3 illustrates a tool operating on a disk clamp to clamp a disk onto a hub, according to one aspect of the present description. Although this disclosure illustrates and describes a tool configured to interface with an compliant portion of an example disk clamp, this disclosure contemplates and includes the tool interfacing with the compliant portion of disk clamp having any suitable configuration of flanges, through holes, and with or without radial channels, for example, the disk clamp previously described in FIGS. 1A-B. Disk clamps 100 and 150 as previously described in FIGS. 1A-B, which may be configured to apply a load onto an inner annulus 308 of disk 206 and clamp one or more disks 206 onto a hub 202. Disk clamps 100 and 150 may not fit over rim 212 of hub 202 with the respective compliant portions straightened or in a relaxed position. With the compliant portion in the relaxed position the inner perimeter of the inner opening of disk clamp 100 is less than the diameter of rim 212 of hub 202, making it difficult to fit disk clamp 100 over hub 202 without the risk of generating particles and damaging one or more the disks 206.

Disk clamp 100 may be configured to fit over a rim 212 of hub 202 when the compliant portion of disk clamp 100 is mechanically deflected axially downward. In some embodiments, bending the compliant portion axially downward may include mechanically deflecting the inner perimeter of disk clamp 100 down in a direction parallel to the central axis of disk clamp 100 or the spindle axis when disk clamp 100 is positioned for clamping, e.g., immediately before fitting the inner perimeter of the disk clamp over rim 212 of hub 202. In other words, the mechanical deflection of the compliant portion of bends the inner perimeter out of a plane defined by the inner perimeter in the non-deflected state to a deflected state for installation on to hub 202. In other embodiments, bending the compliant portion axially downward may include mechanically deflecting flanges down in a direction parallel to the central axis of the disk clamp.

A tool may be configured to interface with disk clamp 100 to mechanically deflect or bend the flanges during installation (or removal) of disk clamp 100. The tool designed in the assembly (or removal) mode to interface with disk clamp 100, the tool may be operable to pick up disk clamp 100, manually deflect the compliant portion of disk clamp 100 axially downward, lower disk clamp 100 onto hub 202, and/or allow the compliant portion of disk clamp 100 to relax or straighten such that the compliant portion occupies annular groove 204 of hub 202, thereby clamping disk 206 onto hub 202.

The tool may be configured to position disc clamp 100 relative to hub 202. In some embodiments, the tool includes a deflection portion 302 and a retention portion 304. Deflection portion 302 of the tool is configured to mechanically deflect the flanges of disk clamp 100 axially downward, whilst retention portion 304 of the tool is configured to hold disk clamp 100 in place. In some embodiments, retention portion 304 interfaces with the rim on the outer perimeter of disk clamp 100. Retention portion 304 of the tool holds the non-compliant portion of disc clamp 100, whilst the deflection portion 302 of the tool mechanically deflects the flanges axially downward, thereby enlarging the inner opening of disc clamp 100.

During an assembly operation, retention portion 304 of the tool holds and maintains tension on disk clamp 100 and deflection portion 302 mechanically deflects a compliant portion of disk clamp 100 such as on the inner perimeter or flanges of disk clamp 100 and 150, respectively. The inner portion of disk clamp 100 are mechanically deflected from a free state to enlarge the inner opening for passage over an outside diameter of rim 212 of hub 202 and into annular groove 204 of hub 202 during the assembly operation. Upon release of the mechanical deflection by deflection portion 302, the compliant portion of disc clamp 100 is restrained by annular groove 204 of hub 202 and precluded from returning to its free, non-deflected state. Preventing the compliant portion from returning to their non-deflected state develops a clamping force on disk clamp 100 that is translated to inner annulus 306 of disk 206 through the bottom portion 218 of the rim of disk clamp 100 in contact with inner annulus 306 of disk 206. In other embodiments, deflecting portion 302 may interface with one or more notches (not shown) of disk clamp 100 to deflect the compliant portion of disk clamp 100.

During a removal operation, retention portion 304 of the tool holds and maintains tension on disk clamp 100 and deflection portion 302 mechanically deflects the compliant portion of disk clamp 100. Mechanically deflecting the flanges of disk clamp 100 from the non-deflected state disengages the compliant portion from annular grove 204 of hub and enlarges the inner opening for passage over the outside diameter of rim 212 of hub 202. Disk clamp 100 may be raised from the contact with inner annulus 306 of disk 206 and above rim 212 of hub 202 by retention portion 304 whilst the compliant portion of disk clamp 100 is mechanically deflected by deflection portion 302.

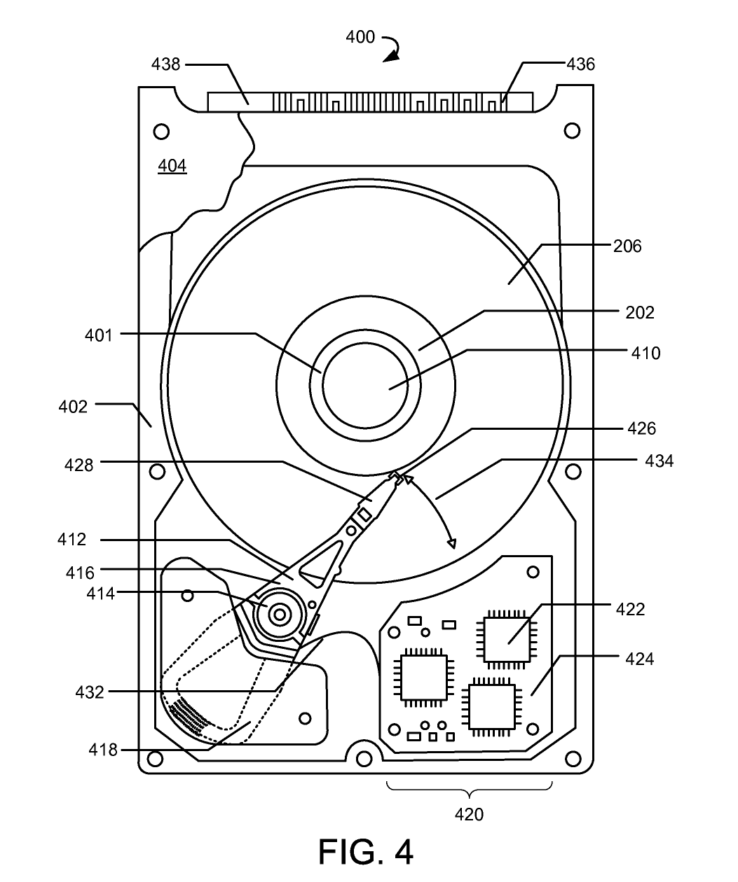

FIG. 4 illustrates a HDD in which embodiments of an example disk clamp may be used, according to one aspect of the present description. Hard disk drive 400 may use disk clamp 401, corresponding for example to disk clamps previously described in FIGS. 1-3. Hard disk drive 400 may include a housing assembly comprising a cover 404 that mates with a base deck having a frame 402 and a floor, which housing assembly provides a protective space for various hard disk drive components. The hard disk drive 400 includes one or more disks 206 of computer-readable data storage media. Typically, both of the major surfaces of each data storage disk 206 include a plurality of concentrically disposed tracks for data storage purposes. Each data storage disk 206 is mounted on a hub 202, which in turn is rotatably interconnected with the base deck and/or cover 404. Multiple disks 206 are typically mounted in vertically spaced and parallel in relation to the hub 202 and may be mounted onto hub 202 using a disk clamp as described in FIGS. 1A-B. A spindle motor assembly 410 rotates the disks 206 of computer-readable data storage media.

The hard disk drive 400 also includes an actuator arm assembly 412 that pivots about a pivot bearing 414, which in turn is rotatably supported by the base deck and/or cover 402. The actuator arm assembly 412 includes one or more individual rigid actuator arms 416 that extend out from near the pivot bearing 414. Multiple actuator arms 416 are typically disposed in vertically spaced relation, with one actuator arm 416 being provided for each major data storage surface of each disk 206 of hard disk drive 400. Other types of actuator arm assembly configurations could be utilized as well, an example being an “E” block having one or more rigid actuator arm tips, or the like, that cantilever from a common structure. Movement of the actuator arm assembly 412 is provided by an actuator arm drive assembly, such as a voice coil motor 418 or the like. The voice coil motor 418 is a magnetic assembly that controls the operation of the actuator arm assembly 412 under the direction of control electronics 420. The control electronics 420 may include a plurality of integrated circuits 422 coupled to a printed circuit board 424. The control electronics 420 may be coupled to the voice coil motor assembly 418, a slider 426, or the spindle motor assembly 410 using interconnects that can include pins, cables, or wires (not shown).

A load beam or suspension 428 is attached to the free end of each actuator arm 416 and cantilevers therefrom. Typically, the suspension 428 is biased generally toward its corresponding disk 206 by a springlike force. The slider 426 is disposed at or near the free end of each suspension 428. What is commonly referred to as the read-write head (e.g., transducer) is appropriately mounted as a head unit (not shown) under the slider 426 and is used in hard disk drive read/write operations. The head unit under the slider 426 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 426 is connected to a preamplifier, which is interconnected with the control electronics 420 of the hard disk drive 400 by a flex cable 432 that is typically mounted on the actuator arm assembly 412. Signals are exchanged between the head unit and its corresponding disk 406 for hard disk drive read/write operations. In this regard, the voice coil motor 418 is utilized to pivot the actuator arm assembly 412 to simultaneously move the slider 426 along a path 434 and across the corresponding disk 206 to position the head unit at the appropriate position on the disk 206 for hard disk drive read/write operations.

When the hard disk drive 400 is not in operation, the actuator arm assembly 412 is pivoted to a “parked position” to dispose each slider 426 generally at or beyond a perimeter of its corresponding disk 206, but in any case in vertically spaced relation to its corresponding data storage disk 206. In this regard, the hard disk drive 400 includes a ramp assembly (not shown) that is disposed beyond a perimeter of the data storage disk 206 to both move the corresponding slider 426 vertically away from its corresponding data storage disk 206 and exert somewhat of a retaining force on the actuator arm assembly 412.

Exposed contacts 436 of a drive connector 438 along a side end of the hard disk drive 400 may be used to provide connectivity between circuitry of the hard disk drive 400 and a next level of integration such as an interposer, a circuit board, a cable connector, or an electronic assembly. The drive connector 438 may include jumpers (not shown) or switches (not shown) that may be used to configure the hard disk drive 400 for user specific features or configurations. The jumpers or switches may be recessed and exposed from within the drive connector 438.

As such, provided herein is an apparatus that includes an inner perimeter, an outer perimeter, and an interperimeteral region of an annulus. The apparatus also includes a top surface and a bottom surface of the annulus and a number of radially extending through holes through the top and bottom surfaces of the interperimeteral region of the annulus.

In some embodiments, two or more of the number of through holes radially extends through a radial channel to the inner perimeter of the annulus forming compliant flanges operable to engage an annular groove of a hub. Each flange may include at least one completely enclosed through hole. In some embodiments, the apparatus is configured to interface with a tool for bending the flanges out of plane and for expanding the inner perimeter to fit over a rim and into an annular groove of the hub. The apparatus is operable to screwlessly clamp at least one disk on a hub, such that the apparatus is operable to clamp at least one disk on a hub with substantially uniform pressure on an inner annulus of the at least one disk. In some embodiments, the outer perimeter includes a rim, where a bottom portion of the rim is operable to apply a substantially uniform pressure on an inner annulus of at least one disk on a hub. Every other through hole of the number of through holes radially extends through a radial channel to the inner perimeter of the annulus.

Also provided herein is an apparatus that includes a radially extending through hole in an interperimeteral region and a radial channel extending from the through hole to an inner perimeter of an annulus. The radially extending through hole and the radial channel define a compliant flange operable to engage an annular groove. In some embodiments, the apparatus also includes a second radially extending through hole without a corresponding radial channel in the interperimeteral region. For example, every other through hole of a number of through holes may extend through a radial channel to the inner perimeter of the annulus. In some embodiments, the apparatus further includes an outer perimeter and a rim. In some embodiments, the bottom portion of the rim is configured to apply a substantially uniform pressure on an inner annulus of a disk on a hub. In some embodiments, the apparatus further includes a number of compliant flanges defined by a number of through holes including corresponding radial channels and a number of through holes without corresponding radial channels.

Also provided herein is an apparatus that includes an interperimeteral region of an annulus and a number of radially extending through holes through the interperimeteral region of the annulus. One or more of the through holes radially extends to an inner perimeter of the annulus, thereby forming flanges operable to engage an annular groove of a hub. A diameter of the inner perimeter is less than an outer diameter of the hub when the flanges are in non-deflected state. The annulus includes a compliant portion and a non-compliant portion, wherein the compliant portion is defined by a configuration of the plurality of through holes. In some embodiments, the radial channels have a width less than a width of the through holes. In other embodiments, the apparatus comprises aluminum, stainless steel, carbon steel, or plastic.

While the invention has been described and/or illustrated by means of various embodiments and/or examples, and while these embodiments and/or examples have been described in considerable detail, it is not the intention of the applicant(s) to restrict or in any way limit the scope of the invention to such detail. Additional adaptations and/or modifications of embodiments of the invention may readily appear to persons having ordinary skill in the art to which the invention pertains, and, in its broader aspects, the invention may encompass these adaptations and/or modifications. Accordingly, departures may be made from the foregoing embodiments and/or examples without departing from the scope of the invention, which scope is limited only by the following claims when appropriately construed. The implementations provided herein and other implementations are within the scope of the following claims.

1. An apparatus comprising:
an inner perimeter, an outer perimeter, and an interperimeteral region of a unitary annulus;
a top surface and a bottom surface of the annulus; and
a plurality of radially extending through holes through the top and bottom surfaces of the interperimeteral region of the annulus,
wherein each through hole of a first set of the plurality of through holes opens at the inner perimeter of the annulus through an interconnecting radial channel,
wherein each through hole of a second set of the plurality of through holes closes at the inner perimeter of the annulus, and
wherein the first and second sets of the plurality of through holes form compliant flanges operable to engage an annular groove of a hub when axially deflected toward the hub.

2. (canceled)

3. The apparatus of claim 1,
wherein each through hole of the plurality of through holes is oval-shaped.

4. The apparatus of claim 1,
wherein the outer perimeter comprises a rim.

5. The apparatus of claim 4,
wherein the rim comprises a bottom portion configured to apply a substantially uniform pressure on an inner annulus of at least one disk on a hub.

6. The apparatus of claim 1,
wherein the first and second sets of the plurality of through holes are configured such that every other through hole of the plurality of through holes opens at the inner perimeter of the annulus.

7. The apparatus of claim 1,
wherein each flange comprises at least one completely enclosed through hole.

8. (canceled)

9. An apparatus comprising:
a plurality of radially extending through holes in an interperimeteral region of a unitary annulus,
wherein each of the plurality of through holes has a uniform, circumferentially measured width over the interperimeteral region; and
a plurality of radial channels respectively connecting a first set of the plurality of through holes to an inner perimeter of the annulus,
wherein each pair of the first set of the plurality of through holes defines a compliant flange operable to engage an annular groove when axially deflected toward the hub.

10. The apparatus of claim 9, further comprising
a second set of the plurality of through holes without corresponding radial channels connecting the second set of the plurality of through holes to the inner perimeter of the annulus.

11. The apparatus of claim 10,
wherein the first and second sets of the plurality of through holes are configured such that every other through holes of a plurality of through holes opens at the inner perimeter of the annulus.

12. The apparatus of claim 9, further comprising an
an outer perimeter and a rim.

13. The apparatus of claim 12,
wherein the rim comprises a bottom portion configured to apply a substantially uniform pressure on an inner annulus of a disk on a hub.

14. (canceled)

15. An apparatus, comprising:
An interperimeteral region of a single pieces annulus;
A plurality of radially extending through holes in the interperimeteral region of the annulus,
wherein each through hole of a first set of the plurality of through holes opens at an inner perimeter of the annulus through an interconnecting radial channel,
wherein each through hole of a second set of the plurality of through holes closes at the inner perimeter of the annulus and
wherein the first and second sets of the plurality of through holes form flanges operable to engage an annular groove of a hub when axially deflected toward the hub.

16. The apparatus of claim 15,
wherein the annulus comprises a complaint portion and a non-compliant portion.

17. The apparatus of claim 16,
wherein the compliant portion is defined by a configuration of the plurality of through holes.

18. The apparatus of claim 15,
wherein the flanges comprises aluminum, stainless steel, carbon steel, or plastic.

19. The apparatus of claim 15,
wherein a diameter of the inner perimeter is less than an outer diameter of a hub when the flanges are in non-deflected state.

20. The apparatus of claim 15,
wherein the radial channels have a circumferentially measured width less than a corresponding width of the through holes.

21. The apparatus of claim 1,
wherein a diameter of the inner perimeter is smaller than an outer diameter of a hub when the flanges are in non-deflected state.

22. The apparatus of claim 1,
wherein each radial channel has a circumferentially measured width less than a corresponding width of the through hole to which the radial channel is connected.

23. The apparatus of claim 9,
wherein each radial channel of the plurality of radial channels has a uniform, circumferentially measured width less than the corresponding width of the through hole to which the radial channel is connected.
